(19) United States
(12) Patent Application Publication
(10) Pub. No.: US 2018/0018363 A1
(43) Pub. Date: Jan. 18, 2018

(54) TIME SERIES DATA PROCESSING METHOD AND APPARATUS

(71) Applicant: Huawei Technologies Co., Ltd., Shenzhen (CN)

(72) Inventors: Xuelian LIN, Beijing (CN); Shuai MA, Beijing (CN); Lei SHI, Beijing (CN); Qi YU, Beijing (CN); Yanping JIANG, Shenzhen (CN); Mitch TSENG, Plano, TX (US)

(21) Appl. No.: 15/702,001

(22) Filed: Sep. 12, 2017

Related U.S. Application Data
(63) Continuation of application No. PCT/CN2015/093378, filed on Oct. 30, 2015.

(30) Foreign Application Priority Data
Mar. 12, 2015 (CN) PCT/CN2015/074107

(51) Int. Cl. G06F 17/30; H04W 4/00; H04L 29/08

(52) U.S. Cl. CPC G06F 17/30371; H04W 4/005; G06F 17/30377; H04L 67/125

(57) ABSTRACT

Embodiments of the present invention provide a time series data processing method and apparatus, where the method includes: first, receiving, by a common services entity CSE, a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and then, processing, by the common services entity CSE, a time series data set according to the request message, and sending a processing result to the application entity AE.

### CROSS-REFERENCE TO RELATED APPLICATIONS

This application is a continuation of International Application No. PCT/CN2015/093378, filed on Oct. 30, 2015, which claims priority to International Application No. PCT/CN2015/074107, filed on Mar. 12, 2015. The disclosures of the aforementioned applications are hereby incorporated by reference in their entireties.

### TECHNICAL FIELD

Embodiments of the present invention relate to communications technologies, and in particular, to a time series data processing method and apparatus.

### BACKGROUND

At present, there are three manners of machine to machine (Machine-To-Machine, M2M for short) wireless communications: machine to machine, machine to mobile phone (such as remote user monitoring), and mobile phone to machine (such as remote user control). A OneM2M standard provides a common M2M service layer. This layer may be embedded into various types of hardware and software, and may connect numerous devices in the field.

The OneM2M standard uses a container resource and a child instance resource to describe data. The two resources include multiple attributes. Storage space corresponding to a content attribute in the child instance resource stores data. For each content attribute, one piece of data is correspondingly stored. However, there is time series data in the prior art, and the time series data is time series data. The time series data is a data series recorded in a time order according to a uniform indicator. It is an inevitable outcome to introduce the time series data to the OneM2M standard. However, there is no specific insert operation, delete operation, or query operation for the time series data in the prior art. Therefore, if multiple pieces of time series data are correspondingly stored for each content attribute, a corresponding operation cannot be performed for one piece or some pieces of time series data, thereby reducing operation reliability.

### SUMMARY

Embodiments of the present invention provide a time series data processing method and apparatus, so as to perform a corresponding search, delete, and insert operation on time series data, thereby improving operation reliability.

According to a first aspect, an embodiment of the present invention provides a time series data processing method, including: receiving, by a common services entity CSE, a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and processing, by the common services entity CSE, a time series data set according to the request message, and sending a processing result to the application entity AE, where the first time series data is a two-dimensional array, including: a first data parameter and a first time parameter, the time series data set includes at least one piece of second time series data, the second time series data is a two-dimensional array, including: a second data parameter and a second time parameter, and the time series data set is stored in storage space corresponding to a container resource in a oneM2M standard.

With reference to the first aspect, in a first possible implementation manner of the first aspect, if the request message carries the first operation type and the at least one piece of first time series data, and the first operation type is the insert operation, the processing, by the common services entity CSE, a time series data set according to the request message specifically includes: determining an insert location of the first time series data according to the first time parameter of the first time series data; and inserting the first time series data into the corresponding insert location.

With reference to the first possible implementation manner of the first aspect, in a second possible implementation manner of the first aspect, the determining an insert location of the first time series data according to the first time parameter of the first time series data specifically includes: if the time series data set stores all the second time series data in ascending order of the second time parameters, querying, by the common services entity CSE, a second time parameter first greater than the first time parameter in ascending order of the second time parameters, and determining a storage location of corresponding second time series data as the insert location; or if the time series data set stores all the second time series data in descending order of the second time parameters, querying, by the common services entity CSE, a second time parameter first less than the first time parameter in descending order of the second time parameters, and determining a storage location of corresponding second time series data as the insert location.

With reference to the first aspect, in a third possible implementation manner of the first aspect, if the request message carries the first operation type and the at least one piece of first time series data, and the first operation type is the delete operation, the processing, by the common services entity CSE, a time series data set according to the request message specifically includes: searching the time series data set for a second time parameter same as the first time parameter, and deleting second time series data corresponding to the second time parameter from the time series data set.

With reference to the first aspect, in a fourth possible implementation manner of the first aspect, if the request message carries the first operation type and the at least one piece of first time series data, and the first operation type is the query operation, the processing, by the common services entity CSE, a time series data set according to the request message specifically includes: querying, in the time series data set, second time series data corresponding to a second time parameter same as the first time parameter.

With reference to the first aspect, in a fifth possible implementation manner of the first aspect, if the request message carries the second operation type and the at least one filter criterion, and the second operation type is the delete operation, the processing, by the common services entity CSE, a time series data set according to the request message specifically includes: if the filter criterion includes two first time parameters, deleting second time series data corresponding to a second time parameter between the two first time parameters in the time series data set; or if the filter criterion includes at least one character field, deleting second time series data corresponding to a second data parameter that includes the at least one character field.

With reference to the first aspect, in a sixth possible implementation manner of the first aspect, if the request message carries the second operation type and the at least one filter criterion, and the second operation type is the query operation, the processing, by the common services entity CSE, a time series data set according to the request message specifically includes: if the filter criterion includes two first time parameters, querying second time series data corresponding to a second time parameter between the two first time parameters in the time series data set; or if the filter criterion includes at least one character field, querying second time series data corresponding to a second data parameter that includes the at least one character field.

According to a second aspect, an embodiment of the present invention provides a time series data processing apparatus, including: a receiving module, configured to receive a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and a processing module, configured to process a time series data set according to the request message, and send a processing result to the application entity AE, where the first time series data is a two-dimensional array, including: a first data parameter and a first time parameter, the time series data set includes at least one piece of second time series data, the second time series data is a two-dimensional array, including: a second data parameter and a second time parameter, and the time series data set is stored in storage space corresponding to a container resource in a oneM2M standard.

With reference to the second aspect, in a first possible implementation manner of the second aspect, if the request message carries the first operation type and the at least one piece of first time series data, and the first operation type is the insert operation, the processing module is specifically configured to: determine an insert location of the first time series data according to the first time parameter of the first time series data; and insert the first time series data into the corresponding insert location.

With reference to the first possible implementation manner of the second aspect, in a second possible implementation manner of the second aspect, the processing module is specifically configured to: if the time series data set stores all the second time series data in ascending order of the second time parameters, query a second time parameter first greater than the first time parameter in ascending order of the second time parameters, and determine a storage location of corresponding second time series data as the insert location; or if the time series data set stores all the second time series data in descending order of the second time parameters, query a second time parameter first less than the first time parameter in descending order of the second time parameters, and determine a storage location of corresponding second time series data as the insert location.

With reference to the second aspect, in a third possible implementation manner of the second aspect, if the request message carries the first operation type and the at least one piece of first time series data, and the first operation type is the delete operation, the processing module is specifically configured to: search the time series data set for a second time parameter same as the first time parameter, and delete second time series data corresponding to the second time parameter from the time series data set.

With reference to the second aspect, in a fourth possible implementation manner of the second aspect, if the request message carries the first operation type and the at least one piece of first time series data, and the first operation type is the query operation, the processing module is specifically configured to: query, in the time series data set, second time series data corresponding to a second time parameter same as the first time parameter.

With reference to the second aspect, in a fifth possible implementation manner of the second aspect, if the request message carries the second operation type and the at least one filter criterion, and the second operation type is the delete operation, the processing module is specifically configured to: if the filter criterion includes two first time parameters, delete second time series data corresponding to a second time parameter between the two first time parameters in the time series data set; or if the filter criterion includes at least one character field, delete second time series data corresponding to a second data parameter that includes the at least one character field.

With reference to the second aspect, in a sixth possible implementation manner of the second aspect, if the request message carries the second operation type and the at least one filter criterion, and the second operation type is the query operation, the processing module is specifically configured to: if the filter criterion includes two first time parameters, query second time series data corresponding to a second time parameter between the two first time parameters in the time series data set; or if the filter criterion includes at least one character field, query second time series data corresponding to a second data parameter that includes the at least one character field.

According to a third aspect, an embodiment of the present invention provides a time series data processing apparatus, including: a receiver, configured to receive a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and a processor, configured to process a time series data set according to the request message, and send a processing result to the application entity AE, where the first time series data is a two-dimensional array, including: a first data parameter and a first time parameter, the time series data set includes at least one piece of second time series data, the second time series data is a two-dimensional array, including: a second data parameter and a second time parameter, and the time series data set is stored in storage space corresponding to a container resource in a oneM2M standard.

With reference to the third aspect, in a first possible implementation manner of the third aspect, if the request message carries the first operation type and the at least one piece of first time series data, and the first operation type is the insert operation, the processor is specifically configured to: determine an insert location of the first time series data according to the first time parameter of the first time series data; and insert the first time series data into the corresponding insert location.

With reference to the first possible implementation manner of the third aspect, in a second possible implementation manner of the third aspect, the processor is specifically configured to: if the time series data set stores all the second time series data in ascending order of the second time parameters, query a second time parameter first greater than the first time parameter in ascending order of the second time parameters, and determine a storage location of corresponding second time series data as the insert location; or if the time series data set stores all the second time series data in descending order of the second time parameters, query a second time parameter first less than the first time parameter in descending order of the second time parameters, and determine a storage location of corresponding second time series data as the insert location.

With reference to the third aspect, in a third possible implementation manner of the third aspect, if the request message carries the first operation type and the at least one piece of first time series data, and the first operation type is the delete operation, the processor is specifically configured to: search the time series data set for a second time parameter same as the first time parameter, and delete second time series data corresponding to the second time parameter from the time series data set.

With reference to the third aspect, in a fourth possible implementation manner of the third aspect, if the request message carries the first operation type and the at least one piece of first time series data, and the first operation type is the query operation, the processor is specifically configured to: query, in the time series data set, second time series data corresponding to a second time parameter same as the first time parameter.

With reference to the third aspect, in a fifth possible implementation manner of the third aspect, if the request message carries the second operation type and the at least one filter criterion, and the second operation type is the delete operation, the processor is specifically configured to: if the filter criterion includes two first time parameters, delete second time series data corresponding to a second time parameter between the two first time parameters in the time series data set; or if the filter criterion includes at least one character field, delete second time series data corresponding to a second data parameter that includes the at least one character field.

With reference to the third aspect, in a sixth possible implementation manner of the third aspect, if the request message carries the second operation type and the at least one filter criterion, and the second operation type is the query operation, the processor is specifically configured to: if the filter criterion includes two first time parameters, query second time series data corresponding to a second time parameter between the two first time parameters in the time series data set; or if the filter criterion includes at least one character field, query second time series data corresponding to a second data parameter that includes the at least one character field.

According to a fourth aspect, an embodiment of the present invention provides a time series data resource management method, including:

receiving, by a hosting common services entity Hosting CSE, an operation request for a time series data resource, where the operation request for the time series data resource is sent by an application entity AE or a common services entity CSE, the operation request carries an operation type and attribute information of the time series data resource, and the operation type is one of the following operations: create, delete, update, and obtain; and

processing, by the Hosting CSE, the time series data resource according to the operation type and the attribute information of the time series data resource, and sending a processing result to the AE or the CSE.

In a possible implementation manner, the time series data resource is used to store time series data information and the attribute information of the time series data resource.

In a possible implementation manner, the time series data information is stored in a time series data instance resource;

the time series data information includes a time at which time series data is collected and/or a time series data value; and

the time series data instance resource is a child resource of the time series data resource.

In a possible implementation manner, the attribute information of the time series data resource includes at least one of data time duplication and a data time type; where

the data time duplication is used to indicate whether times at which time series data of different time series data instance resources are collected are allowed to be the same; and

the data time type is used to indicate whether the time at which the time series data is collected is a relative time or an absolute time.

In a possible implementation manner, the attribute information of the time series data resource further includes a period and data detection.

In a possible implementation manner, the processing, by the Hosting CSE, the time series data resource according to the operation type and the attribute information of the time series data resource includes:

if the operation type is create, verifying, by the Hosting CSE, the attribute information of the time series data resource, and after the verification succeeds, creating the time series data resource; or

if the attribute information of the time series data resource further includes the period and the data detection, detecting, by the Hosting CSE, the time series data according to the period, and when the time series data is missing, storing, by the Hosting CSE, a time at which the time series data is missing.

According to a fifth aspect, another embodiment of the present invention provides a time series data instance resource management method, including:

receiving, by a Hosting CSE, an operation request for a time series data instance resource, where the operation request for the time series data instance resource is sent by an AE or a CSE, and the operation request carries an operation type and attribute information of the time series data instance resource; and

processing, by the Hosting CSE, the time series data instance resource according to the operation type and the attribute information of the time series data instance resource, and sending a processing result to the AE or the CSE.

In a possible implementation manner, the operation type is one of the following operations: create, delete, update, and obtain.

In a possible implementation manner, the attribute information of the time series data instance resource includes at least one of a time at which time series data is collected and a time series data value.

In a possible implementation manner, time series data includes a time at which the time series data is collected and a time series data value. The time series data is stored in a content attribute of a content instance resource. The time at which the time series data is collected is stored in a content time attribute of the content instance resource.

The embodiments of the present invention provide a time series data processing method and apparatus, where the method includes: receiving, by a common services entity CSE, a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and processing, by the common services entity CSE, a time series data set according to the request message, and sending a processing result to the application entity AE, where the first time series data is a two-dimensional array, including: a first data parameter and a first time parameter, the time series data set includes at least one piece of second time series data, the second time series data is a two-dimensional array, including: a second data parameter and a second time parameter, and the time series data set is stored in storage space corresponding to a container resource in a oneM2M standard. Therefore, a corresponding search, delete, and insert operation may be performed on time series data, so as to improve operation reliability.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 shows a schematic architecture diagram of a oneM2M system according to an embodiment of the present invention;

FIG. 2 is a flowchart of a time series data processing method according to an embodiment of the present invention;

FIG. 3A and FIG. 3B are a schematic diagram of a data format according to a oneM2M standard in the prior art;

FIG. 4 is schematic diagram 1 of a data format according to an embodiment of the present invention;

FIG. 5 is schematic diagram 2 of a data format according to an embodiment of the present invention;

FIG. 6 is schematic diagram 3 of a data format according to an embodiment of the present invention;

FIG. 7 is schematic diagram 4 of a data format according to an embodiment of the present invention;

FIG. 8 is schematic diagram 5 of a data format according to an embodiment of the present invention;

FIG. 9 is a schematic structural diagram of a time series data processing apparatus according to an embodiment of the present invention;

FIG. 10 is a schematic structural diagram of a time series data processing apparatus according to another embodiment of the present invention;

FIG. 11 is a flowchart of a time series data processing method according to an embodiment of the present invention;

FIG. 12a1 is schematic diagram 6 of a data format according to an embodiment of the present invention;

FIG. 12a2 is a Chinese format of schematic diagram 6 of a data format according to an embodiment of the present invention;

FIG. 12b1 is schematic diagram 7 of a data format according to an embodiment of the present invention;

FIG. 12b2 is a Chinese format of schematic diagram 7 of a data format according to an embodiment of the present invention;

FIG. 13 is a flowchart of a time series data processing method according to an embodiment of the present invention;

FIG. 14 is a flowchart of a time series data processing method according to an embodiment of the present invention;

FIG. 15 is schematic diagram 8 of a data format according to an embodiment of the present invention;

FIG. 16 is a Chinese format of schematic diagram 8 of a data format according to an embodiment of the present invention; and

FIG. 17 is schematic diagram 9 of a data format according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

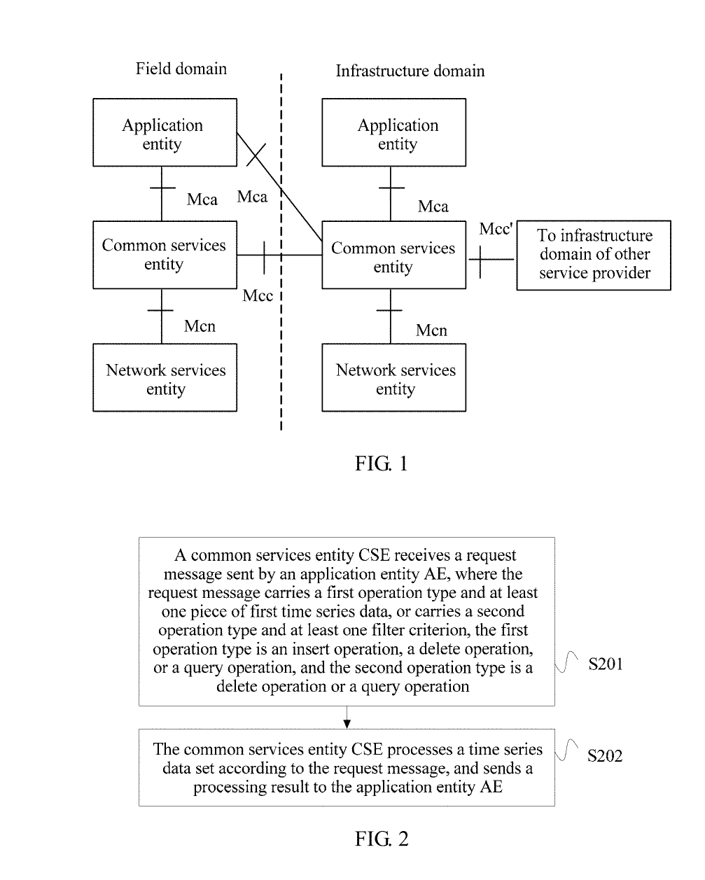

FIG. 1 shows a schematic architecture diagram of a oneM2M system according to an embodiment of the present invention. As shown in FIG. 1, the oneM2M system is divided into an application layer, a common services layer, and a network layer. At the application layer, an application entity (Application Entity, AE for short) is responsible for management of an application-related operation and application-related storage. The application layer includes an instantiated end-to-end oneM2M solution. At the common services layer, a common services entity (Common Services Entity, CSE for short) is responsible for management of aggregating application layer information to form a resource pool, and in addition, coordinates underlying network transmission. The CSE is a core layer in the oneM2M and functions as a platform. The common services layer includes a series of instantiated common services functions. At the network layer, a network services entity (Network Services Entity, NSE for short) is responsible for management of underlying network transmission, and provides, for the common services layer, a capability that can be provided by an underlying network.

There are three types of interfaces between layers in the oneM2M system. Mca is an interface between the AE and the CSE, and is responsible for communication from the AE to the CSE or from the CSE to the AE. Mcc and Mcc′ are interfaces between two CSEs, and are responsible for communication between the CSEs. Mcn is an interface between the CSE and the NSE, and is responsible for communication from the CSE to the NSE or from the NSE to the CSE. It should be understood that, in the present invention, all entities in the oneM2M system, for example, an AE, a CSE, and data, are represented in a resource form.

FIG. 2 is a flowchart of a time series data processing method according to an embodiment of the present invention. The method is applicable to a scenario of communication between terminal devices in the M2M. The method is executed by a time series data processing apparatus, that is, a common services entity (Common Services Entity, CSE for short). The CSE may be an intelligent terminal such as a sensor, a computer, a notebook computer, or a mobile phone. The method includes the following specific process:

S201. The common services entity CSE receives a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation.

S202. The common services entity CSE processes a time series data set according to the request message, and sends a processing result to the application entity AE.

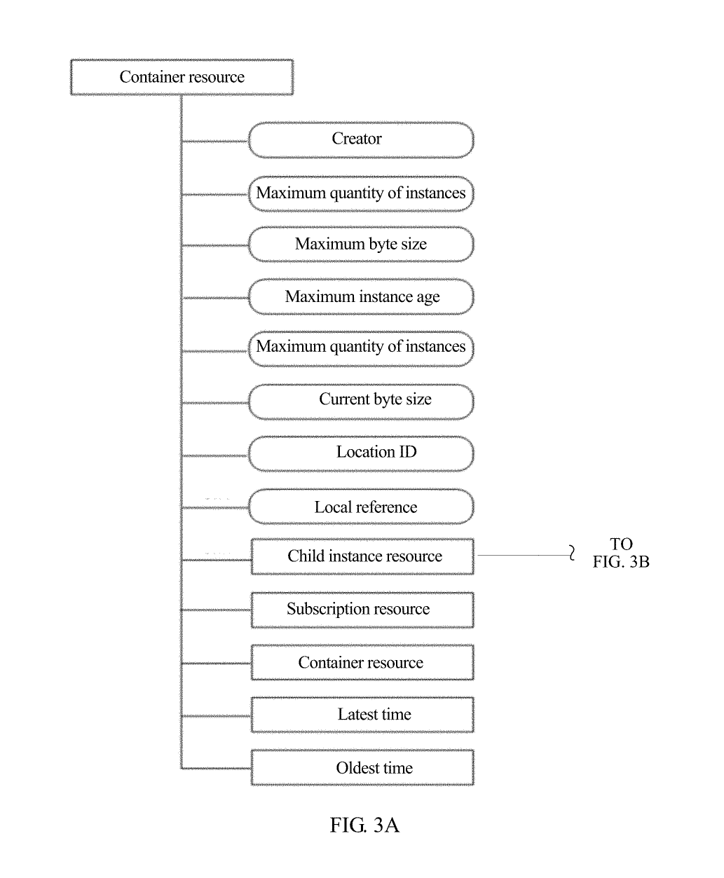

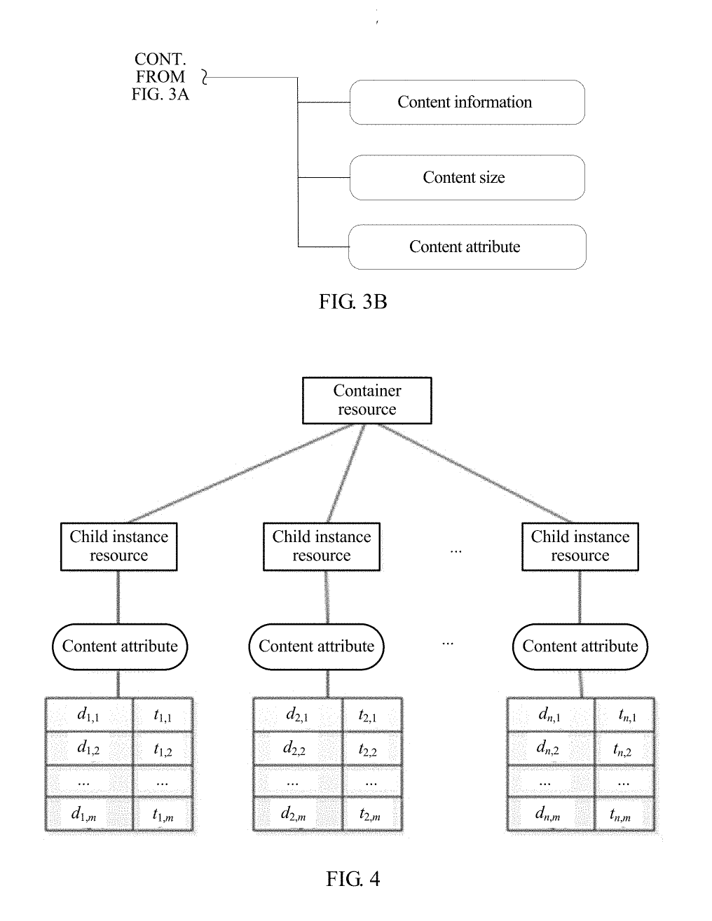

Specifically, the common services entity CSE receives the request message sent by the application entity AE. The application entity AE herein may be an intelligent terminal such as a sensor, a computer, a notebook computer, or a mobile phone. The request message carries the first operation type and the at least one piece of first time series data, or carries the second operation type and the at least one filter criterion. The first operation type is an insert operation, a delete operation, or a query operation, and the second operation type is a delete operation or a query operation. The first time series data is a two-dimensional array, including: a first data parameter and a first time parameter. The time series data set includes at least one piece of second time series data, and the second time series data is a two-dimensional array, including: a second data parameter and a second time parameter. The time series data set is stored in storage space corresponding to a container resource in a oneM2M standard. Certainly, the request message may further carry an application entity AE identifier (Identify, ID for short) or a common services entity CSE identifier. It should be noted that the first time parameter and the second time parameter may be determined by the application entity AE, or may be determined by the common services entity CSE. Therefore, a time parameter in a piece of time series data refers to a time at which the time series data is generated in the application entity AE or the common services entity CSE. The first time series data herein is equivalent to to-be-processed data. The second time series data is data included in the time series data set. A data parameter in the first time series data or the second time series data may be a real number, a picture, or any piece of abstract one-dimensional data. In the prior art, a container resource and a child instance resource are used to describe data. The two resources include multiple attributes, and the multiple attributes include universal attributes. For example, a universal attribute in the container resource includes: a resource type, a resource identifier, a parent node identifier, an expiration time, an access control policy identifier, and a state tag; and a universal attribute in the child instance resource includes: a resource type, a resource identifier, a parent node identifier, a creator, a creation type, and a last modified time. In addition, the container resource and the child instance resource further include specific attributes. FIG. 3A and FIG. 3B are a schematic diagram of a data format according to a oneM2M standard in the prior art. FIG. 3A and FIG. 3B mainly show the specific attributes included in the container resource and the child instance resource.

In the prior art, storage space corresponding to a content attribute in a child instance resource stores data. For each content attribute, one piece of data is correspondingly stored. The data herein refers to any piece of abstract one-dimensional data. However, in real life, time series data is usually used to describe a time-characterized record. For example, populations at the ends of years from 2005 to 2014 in one province are represented by a time series data array including 10 time point numbers. A data parameter of each piece of time series data is population, and a time parameter of each piece of time series data is year.

Further, the time series data may be represented as item=(c, t), where c indicates the data parameter, and t indicates the time parameter. The time series data set may be represented as DS={(c1, t1), (c2, t2), (cn, tn)}, or DS={item1, item2, itemn}, and there is a partial ordering relation between [symbol] DS,≦ [symbol] and the time series data set DS. Storage of time series data may include the following four cases:

1. Based on the data format shown in FIG. 3A and FIG. 3B, FIG. 4 is schematic diagram 1 of a data format according to an embodiment of the present invention. As shown in FIG. 4, time series data may be stored in storage space corresponding to a content attribute, and the storage space may store multiple pieces of time series data. A container resource and a child instance resource herein are in a one-to-one or one-to-many correspondence. Multiplicity of a content attribute is set to “L” instead of “1” in the prior art, where L indicates an attribute list. The multiplicity herein indicates a quantity of pieces of data that can be stored in storage space corresponding to the content attribute. “WO” in a content attribute in the prior art is changed to “RW”. “WO” indicates that creation cannot be changed once completed, and “RW” indicates read and write.

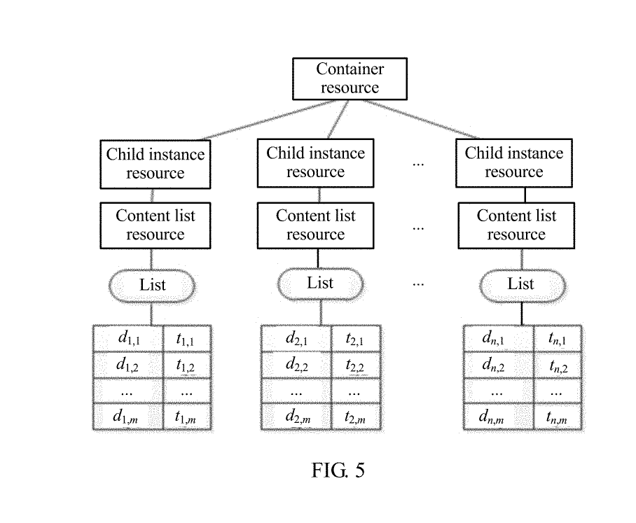

2. Based on the data format shown in FIG. 3A and FIG. 3B, FIG. 5 is schematic diagram 2 of a data format according to an embodiment of the present invention. With reference to FIG. 3A and FIG. 3B, content attribute information in a child instance resource in the prior art indicates a type of data stored in a content attribute. The time series data is introduced to the present invention. Therefore, a time series data item is further added to a stored data type in a content attribute information item, and this indicates that the child instance resource further stores the time series data. However, the content attribute does not directly store the time series data but stores a uniform resource identifier (uniform resource identifier, URI for short). The URI herein is equivalent to a pointer and points to a new resource type: a content list resource. As shown in FIG. 5, a content list resource and a child instance resource are in a one-to-one correspondence. The content list resource includes three items: a child instance resource identifier, a last update time, and a list. As shown in Table 1, MA indicates mandatory announcement, OA indicates optional announcement, NA indicates no announcement, RW indicates read and write, RO indicates read only, and WO indicates write once.

| | | RW/ | | Content list |
|---|---|---|---|---|
| Content list | | RO/ | | announcement |
| resource | Multiplicity | WO | Description | attribute |
| Child | 1 | WO | Identifier of a child | OA |
| instance | | | instance resource | |
| resource | | | corresponding to the | |
| identifier | | | content list resource | |
| Last update | 1 | RO | Last time at which | NA |
| time | | | the content list | |
| | | | resource is updated | |
| List | L | RW | This item stores at | OA |
| | | | least one piece of | |
| | | | time series data | |

3. Based on the data format shown in FIG. 3A and FIG. 3B, a difference between case 3 and case 2 lies in that the content attribute in case 3 does not store a URI but merely stores non-time-series data, that is, one-dimensional data. The one-dimensional data and the content attribute are in a one-to-one correspondence. However, a content list resource is the same as that shown in FIG. 5. In addition, a difference between case 3 and the foregoing two cases lies in that, based on FIG. 3A and FIG. 3B, a content size and the content attribute in case 3 change to some extent. The content size refers to a size of space occupied by data in the content attribute. A content list resource item is added. Therefore, the content size is changed to the size of space occupied by the data in the content attribute and/or a size of space occupied by time series data in the content list resource. In addition, if a data type in content information is non-time-series data, a multiplicity value of the content attribute is “1”, and a multiplicity value of the content list resource is “0”; or if a data type in content information is time series data, a multiplicity value of the content attribute is “0”, and a multiplicity value of the content list resource is “L”, where L is an attribute list.

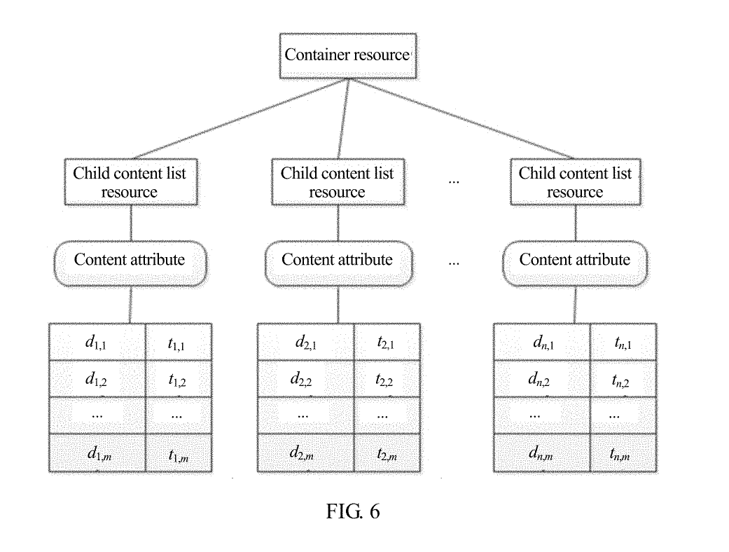

4. Based on the data format shown in FIG. 3A and FIG. 3B, FIG. 6 is schematic diagram 3 of a data format according to an embodiment of the present invention. With reference to FIG. 6, a difference between case 4 and the foregoing three cases lies in that the container resource herein includes not only a child instance resource but also a child content list resource juxtaposed with the child instance resource. An attribute included in the child content list resource is similar to an attribute included in the child instance resource. However, in FIG. 6, storage space corresponding to a content attribute in the child content list resource stores time series data, and the time series data in the content attribute can be read and written, that is, RW.

Further, based on the foregoing definition that the time series data is a two-dimensional array, three operations different from those in the prior art may be defined: an insert operation, a delete operation, and a query operation. Regardless of whether a time series data storage manner is which of the foregoing four cases, multiple pieces of time series data are generally stored, and all the foregoing three operations are implemented based on a time parameter in the time series data. If receiving a request message sent by the application entity AE, where the request message carries a first operation type and at least one piece of first time series data, for example, the request message carries the first operation type: a delete operation, and one piece of first time series data, the common services entity CSE may search a time series data set for the first time series data. If there is the first time series data in the time series data set, the common services entity CSE directly deletes the first time series data. If the request message carries a second operation type and at least one filter criterion, for example, the second operation type is the delete operation, and the filter criterion has a time parameter range, the common services entity CSE deletes second time series data, whose time parameter falls within the range, in the time series data set. Finally, the common services entity CSE sends a processing result to the application entity AE.

This embodiment of the present invention provides a time series data processing method, including: receiving, by a common services entity CSE, a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and processing, by the common services entity CSE, a time series data set according to the request message, and sending a processing result to the application entity AE, where both the first time series data and second time series data are two-dimensional arrays, and the time series data set includes at least one piece of second time series data. According to the processing method provided in this embodiment of the present invention, in comparison with the prior art, a corresponding operation may be performed for one piece or some pieces of second time series data in the time series data set, thereby improving operation reliability.

Based on the foregoing embodiment, optionally, if the request message carries the first operation type and the at least one piece of first time series data, and the first operation type is the insert operation, the processing, by the common services entity CSE, a time series data set according to the request message specifically includes: determining an insert location of the first time series data according to the first time parameter of the first time series data; and inserting the first time series data into the corresponding insert location.

The determining an insert location of the first time series data according to the first time parameter of the first time series data specifically includes: first, if the time series data set stores all second time series data in ascending order of second time parameters, querying a second time parameter first greater than the first time parameter in ascending order of the second time parameters, and determining a storage location of corresponding second time series data as the insert location; or second, if the time series data set stores all second time series data in descending order of second time parameters, querying a second time parameter first less than the first time parameter in descending order of the second time parameters, and determining a storage location of corresponding second time series data as the insert location.

For example, it is assumed that the first operation type carried in the request message is an insert operation, and the first time series data is (50, 2009). Before the common services entity CSE performs the insert operation, a time series data set of the common services entity CSE is {(40, 2007), (39, 2008), (42, 2010)}. Then, a process of determining the insert location according to a first time parameter 2009 is: when the time series data set stores all the second time series data in ascending order of second time parameters, querying a second time parameter first greater than the first time parameter in ascending order of the second time parameters. Therefore, the second time parameter that is found in this example and that is first greater than the first time parameter is 2010. In this case, a storage location of (42, 2010) is determined as an insert location of the first time series data.

Optionally, if the request message carries the first operation type and the at least one piece of first time series data, and the first operation type is the delete operation, the processing, by the common services entity CSE, a time series data set according to the request message specifically includes: searching the time series data set for a second time parameter same as the first time parameter, and deleting second time series data corresponding to the second time parameter from the time series data set.

Further, if the request message carries the first operation type and the at least one piece of first time series data, and the first operation type is the query operation, the processing, by the common services entity CSE, a time series data set according to the request message specifically includes: querying, in the time series data set, second time series data corresponding to a second time parameter same as the first time parameter.

If the request message carries the second operation type and the at least one filter criterion, and the second operation type is the delete operation, the processing, by the common services entity CSE, a time series data set according to the request message specifically includes: if the filter criterion includes two first time parameters, deleting second time series data corresponding to a second time parameter between the two first time parameters in the time series data set; or if the filter criterion includes at least one character field, deleting second time series data corresponding to a second data parameter that includes the at least one character field.

For example, it is assumed that a time series data set of the common services entity CSE is {(40, 2007), (39, 2008), (50, 2009), (42, 2010)}. When the second operation type carried in the request message is a delete operation, and a given filter criterion is that two time parameters are 2008 and 2010, the common services entity CSE carries, according to the request message, second time series data whose second time parameter is between 2008 and 2010. In this example, (50, 2009) needs to be deleted.

For another example, it is assumed that a time series data set of the common services entity CSE is {(40, 2007), (400, 2008), (4000, 2009), (40000, 2010)}. When the second operation type carried in the request message is a delete operation, and a given filter criterion is a character field “400*”, the common services entity CSE deletes, according to the request message, second time series data corresponding to a second data parameter that includes a character field “400”. In this example, (400, 2008), (4000, 2009), and (40000, 2010) need to be deleted.

Optionally, if the request message carries the second operation type and the at least one filter criterion, and the second operation type is the query operation, the processing, by the common services entity CSE, a time series data set according to the request message specifically includes: if the filter criterion includes two first time parameters, querying second time series data corresponding to a second time parameter between the two first time parameters in the time series data set; or if the filter criterion includes at least one character field, querying second time series data corresponding to a second data parameter that includes the at least one character field.

In the foregoing examples, corresponding operation processing is performed for a time series data set. In addition, the foregoing insert operation, delete operation, and query operation may be performed for an attribute. For example, the delete operation is performed for a content attribute, that is, the delete operation is to delete all time series data stored in storage space corresponding to the content attribute.

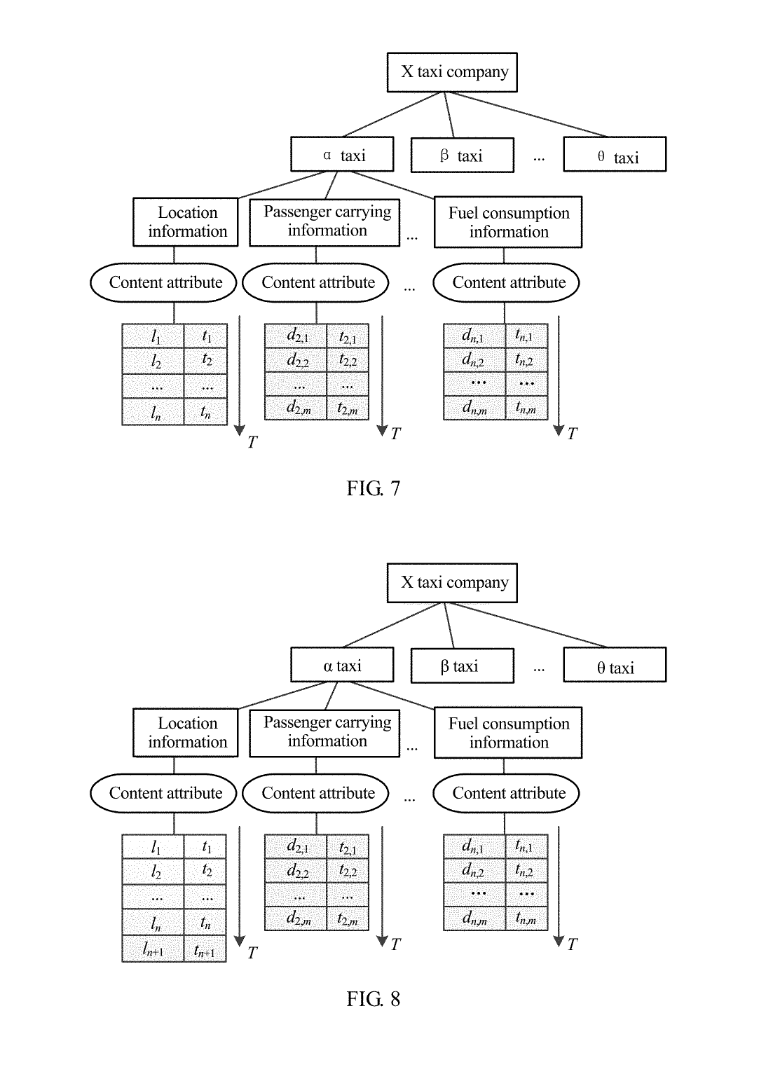

For example, CSEs of an X taxi company store uploaded data of all taxis of the company, and a taxi of the company sends location information of the taxi to the CSE of the company at an interval of 30 seconds. For example, location information of a α taxi stored in the CSE of the company may be described as GPS_{α}={(l₁, t₁), (l₂, t₂), . . . , (lₙ t)|t₁<t₂< . . . <tₙ}. lᵢ indicates a location coordinate of the α taxi in an i^{th} time of statistics collecting, and tᵢ indicates a time at which the i^{th} time of statistics collecting is performed. Certainly, when statistics collecting is performed, passenger carrying information of the α taxi, fuel consumption information of the α taxi, or the like, may further be included. FIG. 7 is schematic diagram 4 of a data format according to an embodiment of the present invention. A α taxi item herein corresponds to the foregoing container resource. The location information, the passenger carrying information, and the fuel consumption information correspond to the foregoing child instance resources, and storage space corresponding to a content attribute included in each child instance resource includes at least one piece of time series data. The α taxi automatically sends location information GPS′_{α}={(lₙ₊₁, tₙ₊₁)} of the α taxi to the CSE of the company every 30 seconds. The location information is equivalent to the foregoing first time series data. After receiving the first time series data, the CSE may perform an insert operation. FIG. 8 is schematic diagram 5 of a data format according to an embodiment of the present invention. After the insert operation is completed, time series data stored in the storage space corresponding to the content attribute is combined into:

GPS_{α}={(l₁,t₁),(l₂,t₂), . . . ,(lₙ,tₙ),(lₙ₊₁,tₙ₊₁)|t₁<t₂<<tₙ<tₙ₊₁}.

The foregoing case is relatively special. Generally, to avoid occupying a resource such as a communications channel, a vehicle sends some pieces or dozens of pieces of location information once:

GPS′_{α}={(lₙ₊₁, tₙ₊₁), (lₙ₊₂, tₙ₊₂) . . . , (lₙ₊ₘ,tₙ₊ₘ)|tₙ₊₁<tₙ₊₂ . . . <tₙ₊ₘ}. When the CSE of the company performs the insert operation, m pieces of first time series data are included. After the insert operation is completed,

GPS_{α}={(l₁,t₁),(l₂,t₂), . . . ,(lᵢ,tᵢ), . . . ,(lₙ,tₙ),(lₙ₊₁,tₙ₊₁), . . . ,(lₙ₊ₘ,tₙ₊ₘ)|t₁<t₂< . . . <tₙ< . . . <tₙ₊₁<, . . . ,tₙ₊ₘ}

When the α taxi queries location information of the α taxi in a specific time period, the CSE performs a query operation. The α taxi may query time series data whose time parameter is between tᵢ and tⱼ.

In conclusion, first, all the insert operation, the delete operation, and the query operation provided in the present invention are to perform a corresponding operation for one piece or multiple pieces of time series data in a time series data set. Therefore, operation reliability is improved. Second, the time series data is a two-dimensional array. Therefore, insertion, deletion, or query may be performed according to a time parameter of the time series data, thereby improving operation efficiency.

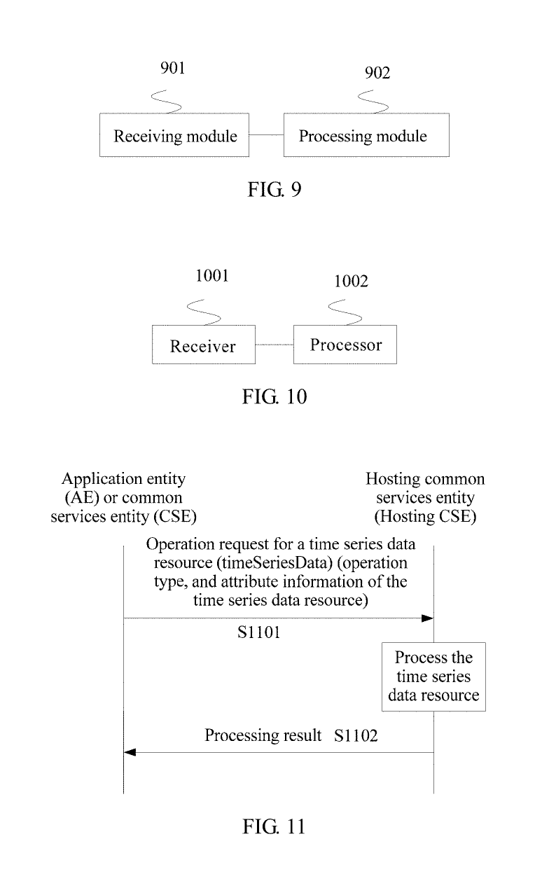

FIG. 9 is a schematic structural diagram of a time series data processing apparatus according to an embodiment of the present invention. The apparatus may be a common services entity (Common Services Entity, CSE for short). The CSE may be an intelligent terminal such as a sensor, a computer, a notebook computer, or a mobile phone. The CSE specifically includes: a receiving module 901, configured to receive a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and a processing module 902, configured to process a time series data set according to the request message, and send a processing result to the application entity AE, where the first time series data is a two-dimensional array, including: a first data parameter and a first time parameter, the time series data set includes at least one piece of second time series data, the second time series data is a two-dimensional array, including: a second data parameter and a second time parameter, and the time series data set is stored in storage space corresponding to a container resource in a oneM2M standard.

In a first optional manner, if the request message carries the first operation type and the at least one piece of first time series data, and the first operation type is the insert operation, the processing module 902 is specifically configured to: determine an insert location of the first time series data according to the first time parameter of the first time series data; and insert the first time series data into the corresponding insert location. Further, the processing module 902 is specifically configured to: if the time series data set stores all second time series data in ascending order of second time parameters, query a second time parameter first greater than the first time parameter in ascending order of the second time parameters, and determine a storage location of corresponding second time series data as the insert location; or if the time series data set stores all second time series data in descending order of second time parameters, query a second time parameter first less than the first time parameter in descending order of the second time parameters, and determine a storage location of corresponding second time series data as the insert location.

In a second optional manner, if the request message carries the first operation type and the at least one piece of first time series data, and the first operation type is the delete operation, the processing module 902 is specifically configured to: search the time series data set for a second time parameter same as the first time parameter, and delete second time series data corresponding to the second time parameter from the time series data set.

In a third optional manner, if the request message carries the first operation type and the at least one piece of first time series data, and the first operation type is the query operation, the processing module 902 is specifically configured to: query, in the time series data set, second time series data corresponding to a second time parameter same as the first time parameter.

In a fourth optional manner, if the request message carries the second operation type and the at least one filter criterion, and the second operation type is the delete operation, the processing module 902 is specifically configured to: if the filter criterion includes two first time parameters, delete second time series data corresponding to a second time parameter between the two first time parameters in the time series data set; or if the filter criterion includes at least one character field, delete second time series data corresponding to a second data parameter that includes the at least one character field.

In a fifth optional manner, if the request message carries the second operation type and the at least one filter criterion, and the second operation type is the query operation, the processing module 902 is specifically configured to: if the filter criterion includes two first time parameters, query second time series data corresponding to a second time parameter between the two first time parameters in the time series data set; or if the filter criterion includes at least one character field, query second time series data corresponding to a second data parameter that includes the at least one character field.

The time series data processing apparatus provided in this embodiment is configured to execute the implementation technical solution of the time series data processing method corresponding to FIG. 2. Implementation principles and technical effects of the apparatus are similar to those of the method. Details are not described herein.

FIG. 10 is a schematic structural diagram of a time series data processing apparatus according to another embodiment of the present invention. The apparatus may be a common services entity CSE. The CSE may be an intelligent terminal such as a sensor, a computer, a notebook computer, or a mobile phone. The CSE specifically includes: a receiver 1001, configured to receive a request message sent by an application entity AE, where the request message carries a first operation type and at least one piece of first time series data, or carries a second operation type and at least one filter criterion, the first operation type is an insert operation, a delete operation, or a query operation, and the second operation type is a delete operation or a query operation; and a processor 1002, configured to process a time series data set according to the request message, and send a processing result to the application entity AE, where the first time series data is a two-dimensional array, including: a first data parameter and a first time parameter, the time series data set includes at least one piece of second time series data, the second time series data is a two-dimensional array, including: a second data parameter and a second time parameter, and the time series data set is stored in storage space corresponding to a container resource in a oneM2M standard.

In a first possible implementation manner, if the request message carries the first operation type and the at least one piece of first time series data, and the first operation type is the insert operation, the processor 1002 is specifically configured to: determine an insert location of the first time series data according to the first time parameter of the first time series data; and insert the first time series data into the corresponding insert location. The processor 1002 is specifically configured to: if the time series data set stores all second time series data in ascending order of second time parameters, query a second time parameter first greater than the first time parameter in ascending order of the second time parameters, and determine a storage location of corresponding second time series data as the insert location; or if the time series data set stores all second time series data in descending order of second time parameters, query a second time parameter first less than the first time parameter in descending order of the second time parameters, and determine a storage location of corresponding second time series data as the insert location.

In a second possible implementation manner, if the request message carries the first operation type and the at least one piece of first time series data, and the first operation type is the delete operation, the processor 1002 is specifically configured to: search the time series data set for a second time parameter same as the first time parameter, and delete second time series data corresponding to the second time parameter from the time series data set.

In a third possible implementation manner, if the request message carries the first operation type and the at least one piece of first time series data, and the first operation type is the query operation, the processor 1002 is specifically configured to: query, in the time series data set, second time series data corresponding to a second time parameter same as the first time parameter.

In a fourth possible implementation manner, if the request message carries the second operation type and the at least one filter criterion, and the second operation type is the delete operation, the processor 1002 is specifically configured to: if the filter criterion includes two first time parameters, delete second time series data corresponding to a second time parameter between the two first time parameters in the time series data set; or if the filter criterion includes at least one character field, delete second time series data corresponding to a second data parameter that includes the at least one character field.

In a fifth optional manner, if the request message carries the second operation type and the at least one filter criterion, and the second operation type is the query operation, the processor 1002 is specifically configured to: if the filter criterion includes two first time parameters, query second time series data corresponding to a second time parameter between the two first time parameters in the time series data set; or if the filter criterion includes at least one character field, query second time series data corresponding to a second data parameter that includes the at least one character field.

The time series data processing apparatus provided in this embodiment is configured to execute the implementation technical solution of the time series data processing method corresponding to FIG. 2. Implementation principles and technical effects of the apparatus are similar to those of the method. Details are not described herein.

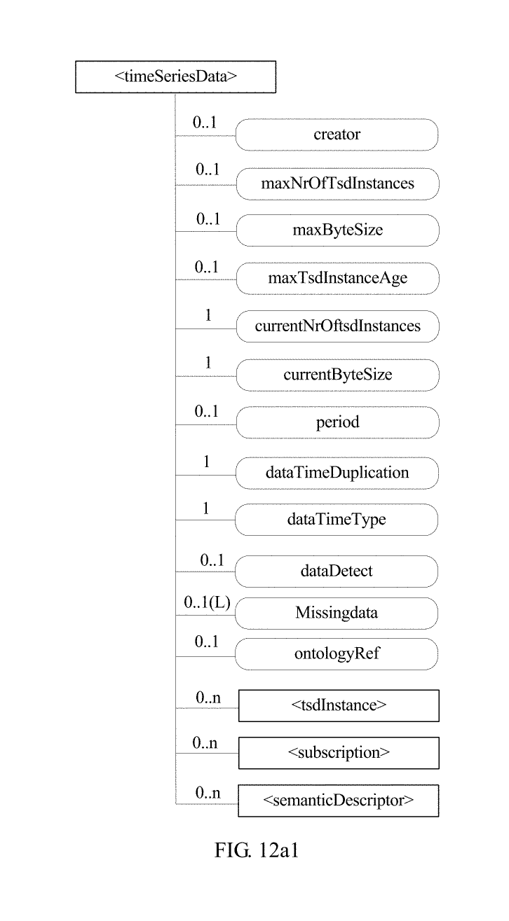

As shown in FIG. 11, an embodiment of the present invention provides a time series data resource management method, including:

S1101. A hosting common services entity Hosting CSE receives an operation request for a time series data resource, where the operation request for the time series data resource is sent by an application entity AE or a common services entity CSE, the operation request carries an operation type and attribute information of the time series data resource, and the operation type is one of the following operations: create, delete, update, and obtain.

S1102. The Hosting CSE processes the time series data resource according to the operation type and the attribute information of the time series data resource, and sends a processing result to the AE or the CSE.

The time series data resource is used to store time series data information and the attribute information of the time series data resource.

The time series data information is stored in a time series data instance resource.

The time series data information includes a time at which time series data is collected and/or a time series data value.

The time series data instance resource is a child resource of the time series data resource.

Optionally, in an embodiment, an example is used to describe a relationship between a time series data resource (timeSeriesData) and a time series data instance resource (tsdInstance).

As shown in FIG. 17, in an example of actual application in which time series data may be used, an M2M device records human heartbeat information, which is recorded once every minute. Data recorded each time includes: a record time and a heartbeat quantity.

All records of heartbeat information of a person are stored in a time series data resource (timeSeriesData), and each specific piece of record information is stored in a time series data instance resource (tsdInstance). That is, the time series data resource (timeSeriesData) is a time series data instance resource (tsdInstance) set. A specific oneM2M resource structure is reflected as follows: A time series data instance resource (tsdInstance) is a child resource of a time series data resource (timeSeriesData), and the time series data resource (timeSeriesData) may have multiple child time series data instance resources (tsdInstance). A time and a data value recorded each time correspond to two attributes of the time series data instance resource (tsdInstance).

The attribute information of the time series data resource includes at least one of data time duplication and a data time type.

The data time duplication is used to indicate whether times at which time series data of different time series data instance resources are collected are allowed to be the same.

The data time type is used to indicate whether the time at which the time series data is collected is a relative time or an absolute time.

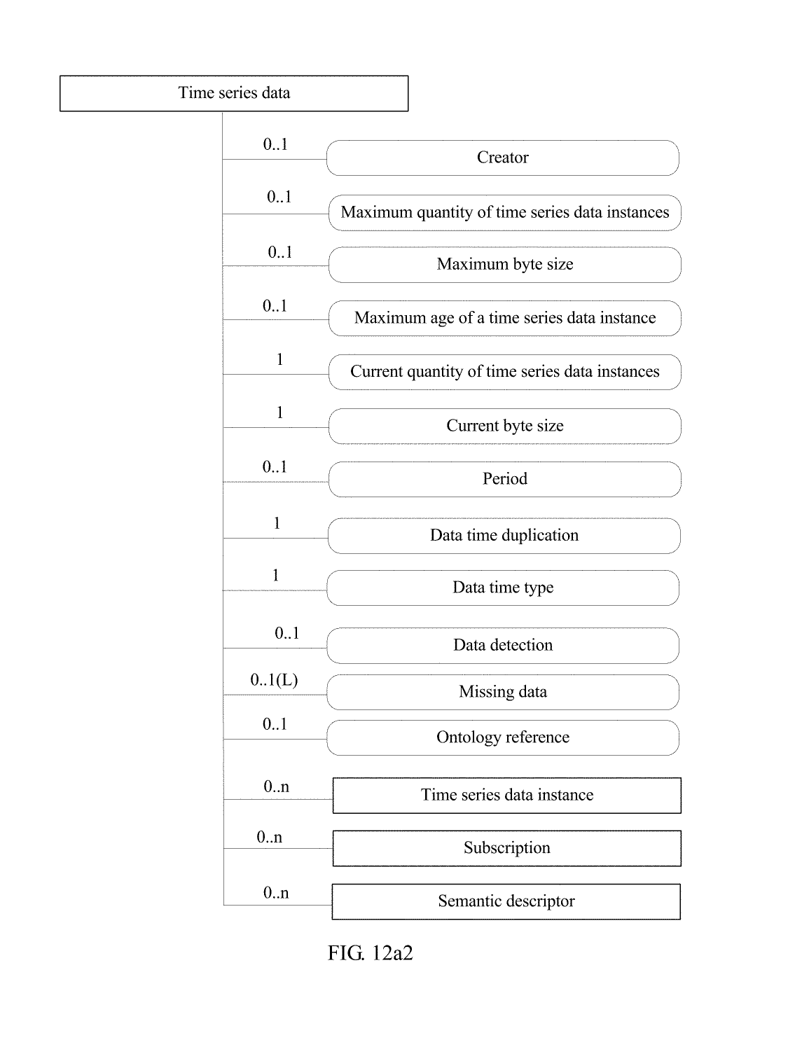

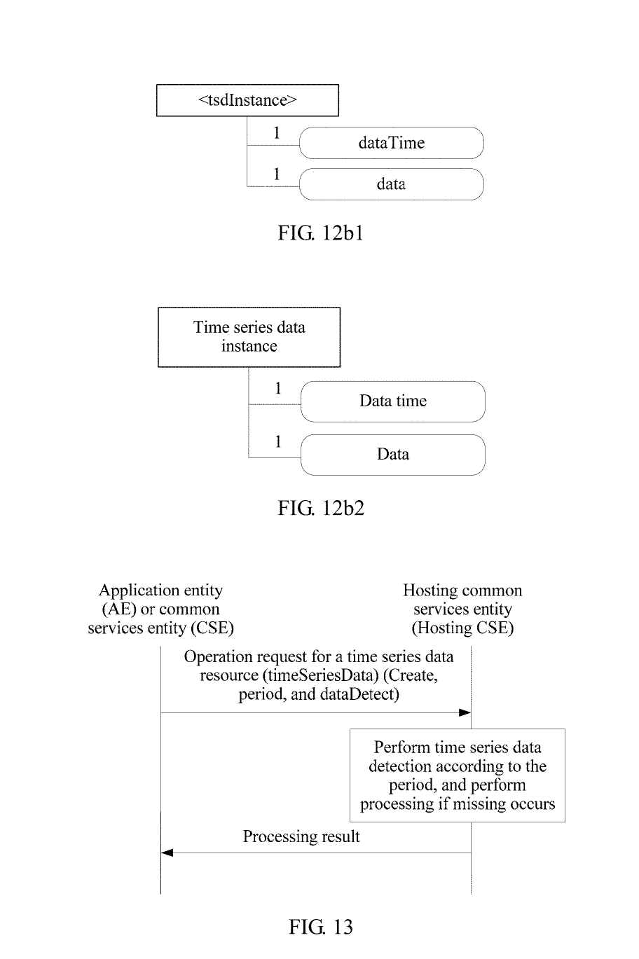

This embodiment describes a function of a time series data resource (timeSeriesData resource) and a specific resource structure: attribute information and child resources. It should be noted that, only two types of attribute information are listed in this embodiment: data time duplication and a data time type. In another embodiment, one or more pieces of attribute information shown in a round rectangle in FIG. 12a1 (FIG. 12a2 is a corresponding figure with a Chinese name) may be included.

A time series data resource (timeSeriesData resource) and a time series data instance resource (tsdInstance resource) may be understood as: All time series data records of a same object (for example, human heartbeat information collection) are stored in the timeSeriesData, and each record is stored in the tsdInstnace.

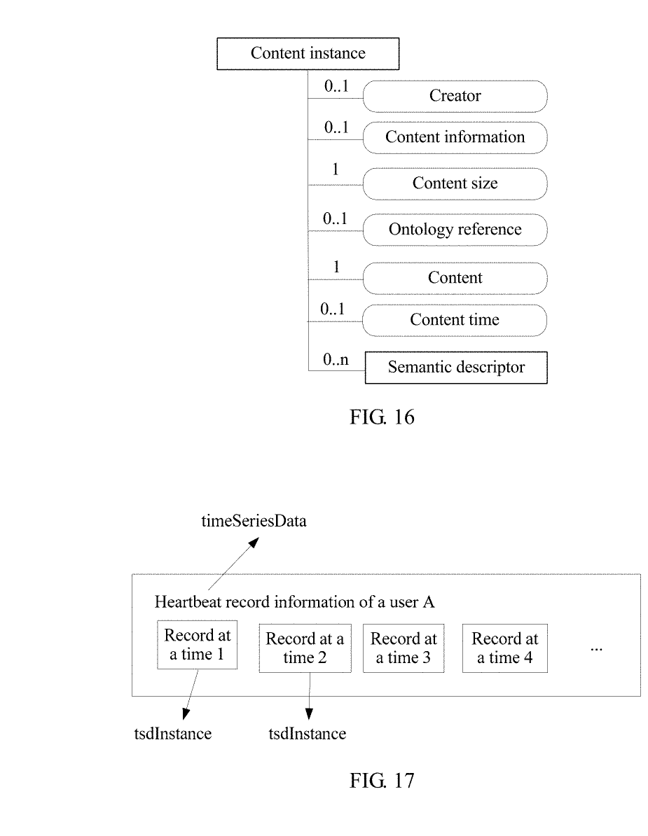

Two new resource structures are shown in FIG. 12a1 (FIG. 12a2 is a corresponding figure with a Chinese name) and FIG. 12b1 (FIG. 12b2 is a corresponding figure with a Chinese name). A round rectangle in the figures indicates an attribute of a resource, and a square rectangle indicates a child resource of the resource. 1 on a horizontal line indicates mandatory; 0 indicates a child resource/attribute shall not be present; 0 . . . 1 indicates optional; 0 . . . n indicates optional, and if present, attributes in multiple corresponding round rectangles or child resources in square rectangles are supported; 1 . . . n indicates mandatory and at least one instance, and attributes in multiple corresponding round rectangles or child resources in square rectangles are supported; and L indicates a list (a list of values). It should be noted that this explanation is also applicable to FIG. 15 and FIG. 16.

In an embodiment, the attribute information of the time series data resource further includes a period and data detection.

Specifically, as shown in FIG. 13, in an embodiment, the processing, by the Hosting CSE, the time series data resource according to the operation type and the attribute information of the time series data resource includes:

if the operation type is create, verifying, by the Hosting CSE, the attribute information of the time series data resource, and after the verification succeeds, creating the time series data resource; or

if the attribute information of the time series data resource further includes the period and the data detection, detecting, by the Hosting CSE, the time series data according to the period, and when the time series data is missing, storing, by the Hosting CSE, a time at which the time series data is missing.

Herein, when a time series data resource (timeSeriesData resource) Create Request operation is performed, if a time series data resource carries two pieces of attribute information: period and dataDetect, the hosting CSE correspondingly sets a specific operation.

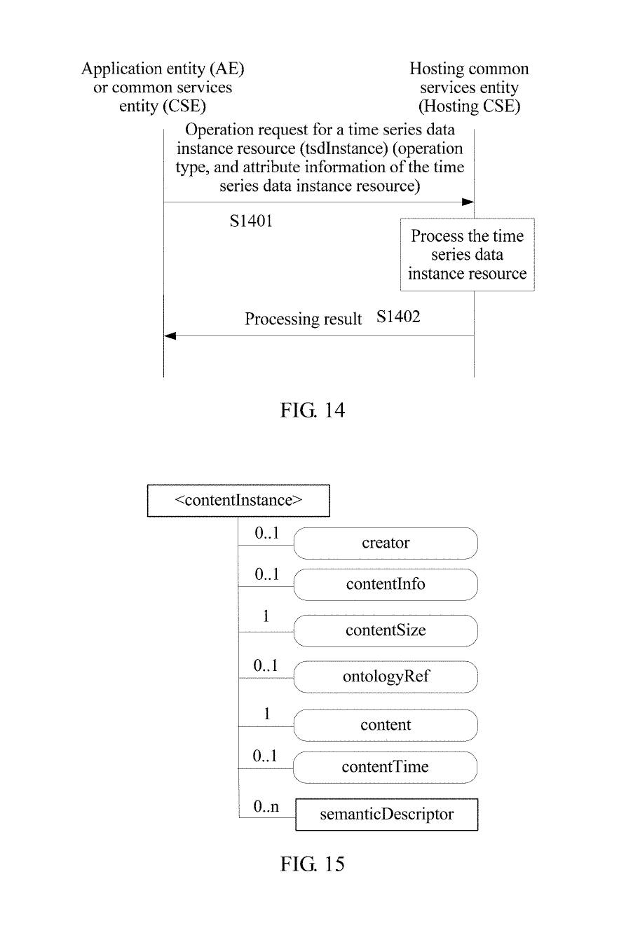

As shown in FIG. 14, another embodiment of the present invention provides a time series data instance resource management method, including:

S1401. A Hosting CSE receives an operation request for a time series data instance resource, where the operation request for the time series data instance resource is sent by an AE or a CSE, and the operation request carries an operation type and attribute information of the time series data instance resource.

S1402. The Hosting CSE processes the time series data instance resource according to the operation type and the attribute information of the time series data instance resource, and sends a processing result to the AE or the CSE.

The operation type is one of the following operations: create, delete, update, and obtain.

The attribute information of the time series data instance resource includes at least one of a time at which time series data is collected and a time series data value.

This embodiment describes attribute information of a time series data instance resource (tsdInstance resource). A structure of the tsdInstance resource is the structure shown in FIG. 12b1.

It should be noted that, in another embodiment of the present invention, as shown in FIG. 15 (FIG. 16 is a corresponding figure with a Chinese name), time series data includes a time at which the time series data is collected and a time series data value. The time series data is stored in a content attribute of a content instance resource. The time at which the time series data is collected is stored in a content time attribute of the content instance resource.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A time series data processing method, comprising:
receiving, by a common services entity (CSE), a request message sent by an application entity (AE), wherein the request message carries a first operation type and at least one piece of first time series data, or carries a second operation type and at least one filter criterion, the first operation type is an insert operation, a delete operation, or a query operation, and the second operation type is a delete operation or a query operation; and
processing, by the common services entity CSE, a time series data set according to the request message, and sending a processing result to the application entity AE; wherein
the first time series data is a two-dimensional array, comprising: a first data parameter and a first time parameter, the time series data set comprises at least one piece of second time series data, the second time series data is a two-dimensional array, comprising: a second data parameter and a second time parameter, and the time series data set is stored in storage space corresponding to a container resource in a oneM2M standard.

2. The method according to claim 1, wherein if the request message carries the first operation type and the at least one piece of first time series data, and the first operation type is the insert operation, the processing, by the common services entity CSE, a time series data set according to the request message specifically comprises:
determining an insert location of the first time series data according to the first time parameter of the first time series data; and
inserting the first time series data into the corresponding insert location.

3. The method according to claim 2, wherein the determining an insert location of the first time series data according to the first time parameter of the first time series data specifically comprises:
if the time series data set stores all the second time series data in ascending order of the second time parameters, querying, by the common services entity CSE, a second time parameter first greater than the first time parameter in ascending order of the second time parameters, and determining a storage location of corresponding second time series data as the insert location; or
if the time series data set stores all the second time series data in descending order of the second time parameters, querying, by the common services entity CSE, a second time parameter first less than the first time parameter in descending order of the second time parameters, and determining a storage location of corresponding second time series data as the insert location.

4. The method according to claim 1, wherein if the request message carries the first operation type and the at least one piece of first time series data, and the first operation type is the delete operation, the processing, by the common services entity CSE, a time series data set according to the request message specifically comprises:
searching the time series data set for a second time parameter same as the first time parameter, and deleting second time series data corresponding to the second time parameter from the time series data set.

5. The method according to claim 1, wherein if the request message carries the first operation type and the at least one piece of first time series data, and the first operation type is the query operation, the processing, by the common services entity CSE, a time series data set according to the request message specifically comprises:
querying, in the time series data set, second time series data corresponding to a second time parameter same as the first time parameter.

6. The method according to claim 1, wherein if the request message carries the second operation type and the at least one filter criterion, and the second operation type is the delete operation, the processing, by the common services entity CSE, a time series data set according to the request message specifically comprises:
if the filter criterion comprises two first time parameters, deleting second time series data corresponding to a second time parameter between the two first time parameters in the time series data set; or
if the filter criterion comprises at least one character field, deleting second time series data corresponding to a second data parameter that comprises the at least one character field.

7. The method according to claim 1, wherein if the request message carries the second operation type and the at least one filter criterion, and the second operation type is the query operation, the processing, by the common services entity CSE, a time series data set according to the request message specifically comprises:
if the filter criterion comprises two first time parameters, querying second time series data corresponding to a second time parameter between the two first time parameters in the time series data set; or
if the filter criterion comprises at least one character field, querying second time series data corresponding to a second data parameter that comprises the at least one character field.

8. A time series data processing apparatus, comprising:
a receiving module, configured to receive a request message sent by an application entity AE, wherein the request message carries a first operation type and at least one piece of first time series data, or carries a second operation type and at least one filter criterion, the first operation type is an insert operation, a delete operation, or a query operation, and the second operation type is a delete operation or a query operation; and
a processing module, configured to process a time series data set according to the request message, and send a processing result to the application entity AE; wherein
the first time series data is a two-dimensional array, comprising: a first data parameter and a first time parameter, the time series data set comprises at least one piece of second time series data, the second time series data is a two-dimensional array, comprising: a second data parameter and a second time parameter, and the time series data set is stored in storage space corresponding to a container resource in a oneM2M standard.

9. The apparatus according to claim 8, wherein if the request message carries the first operation type and the at least one piece of first time series data, and the first operation type is the insert operation, the processing module is specifically configured to:
determine an insert location of the first time series data according to the first time parameter of the first time series data; and
insert the first time series data into the corresponding insert location.

10. The apparatus according to claim 9, wherein the processing module is specifically configured to:
if the time series data set stores all the second time series data in ascending order of the second time parameters, query a second time parameter first greater than the first time parameter in ascending order of the second time parameters, and determine a storage location of corresponding second time series data as the insert location; or
if the time series data set stores all the second time series data in descending order of the second time parameters, query a second time parameter first less than the first time parameter in descending order of the second time parameters, and determine a storage location of corresponding second time series data as the insert location.

11. The apparatus according to claim 8, wherein if the request message carries the first operation type and the at least one piece of first time series data, and the first operation type is the delete operation, the processing module is specifically configured to:
search the time series data set for a second time parameter same as the first time parameter, and delete second time series data corresponding to the second time parameter from the time series data set.

12. The apparatus according to claim 8, wherein if the request message carries the first operation type and the at least one piece of first time series data, and the first operation type is the query operation, the processing module is specifically configured to:
query, in the time series data set, second time series data corresponding to a second time parameter same as the first time parameter.

13. The apparatus according to claim 8, wherein if the request message carries the second operation type and the at least one filter criterion, and the second operation type is the delete operation, the processing module is specifically configured to:
if the filter criterion comprises two first time parameters, delete second time series data corresponding to a second time parameter between the two first time parameters in the time series data set; or
if the filter criterion comprises at least one character field, delete second time series data corresponding to a second data parameter that comprises the at least one character field.

14. The apparatus according to claim 8, wherein if the request message carries the second operation type and the at least one filter criterion, and the second operation type is the query operation, the processing module is specifically configured to:
if the filter criterion comprises two first time parameters, query second time series data corresponding to a second time parameter between the two first time parameters in the time series data set; or
if the filter criterion comprises at least one character field, query second time series data corresponding to a second data parameter that comprises the at least one character field.

15. A time series data processing apparatus, comprising:
a receiver, configured to receive a request message sent by an application entity AE, wherein the request message carries a first operation type and at least one piece of first time series data, or carries a second operation type and at least one filter criterion, the first operation type is an insert operation, a delete operation, or a query operation, and the second operation type is a delete operation or a query operation; and
a processor, configured to process a time series data set according to the request message, and send a processing result to the application entity AE; wherein
the first time series data is a two-dimensional array, comprising: a first data parameter and a first time parameter, the time series data set comprises at least one piece of second time series data, the second time series data is a two-dimensional array, comprising: a second data parameter and a second time parameter, and the time series data set is stored in storage space corresponding to a container resource in a oneM2M standard.

16. The apparatus according to claim 15, wherein if the request message carries the first operation type and the at least one piece of first time series data, and the first operation type is the insert operation, the processor is specifically configured to:
determine an insert location of the first time series data according to the first time parameter of the first time series data; and
insert the first time series data into the corresponding insert location.

17. The apparatus according to claim 16, wherein the processor is specifically configured to:
if the time series data set stores all the second time series data in ascending order of the second time parameters, query a second time parameter first greater than the first time parameter in ascending order of the second time parameters, and determine a storage location of corresponding second time series data as the insert location; or
if the time series data set stores all the second time series data in descending order of the second time parameters, query a second time parameter first less than the first time parameter in descending order of the second time parameters, and determine a storage location of corresponding second time series data as the insert location.

18. The apparatus according to claim 15, wherein if the request message carries the first operation type and the at least one piece of first time series data, and the first operation type is the delete operation, the processor is specifically configured to:
search the time series data set for a second time parameter same as the first time parameter, and delete second time series data corresponding to the second time parameter from the time series data set.

19. The apparatus according to claim 15, wherein if the request message carries the first operation type and the at least one piece of first time series data, and the first operation type is the query operation, the processor is specifically configured to:
query, in the time series data set, second time series data corresponding to a second time parameter same as the first time parameter.

20. The apparatus according to claim 15, wherein if the request message carries the second operation type and the at least one filter criterion, and the second operation type is the delete operation, the processor is specifically configured to:
if the filter criterion comprises two first time parameters, delete second time series data corresponding to a second time parameter between the two first time parameters in the time series data set; or
if the filter criterion comprises at least one character field, delete second time series data corresponding to a second data parameter that comprises the at least one character field.

21. The apparatus according to claim 15, wherein if the request message carries the second operation type and the at least one filter criterion, and the second operation type is the query operation, the processor is specifically configured to:
if the filter criterion comprises two first time parameters, query second time series data corresponding to a second time parameter between the two first time parameters in the time series data set; or
if the filter criterion comprises at least one character field, query second time series data corresponding to a second data parameter that comprises the at least one character field.

22. A time series data resource management method, comprising:
receiving, by a hosting common services entity Hosting CSE, an operation request for a time series data resource, wherein the operation request for the time series data resource is sent by an application entity AE or a common services entity CSE, and the operation request carries an operation type and attribute information of the time series data resource; and
processing, by the Hosting CSE, the time series data resource according to the operation type and the attribute information of the time series data resource, and sending a processing result to the AE or the CSE.

23. The method according to claim 22, wherein the operation type is one of the following operations: create, delete, update, and obtain.

24. The method according to claim 22, wherein the time series data resource is used to store time series data information and the attribute information of the time series data resource.

25. The method according to claim 24, wherein the time series data information is stored in a time series data instance resource;
the time series data information comprises a time at which time series data is collected and/or a time series data value; and
the time series data instance resource is a child resource of the time series data resource.

26. The method according to claim 22, wherein the attribute information of the time series data resource comprises at least one of data time duplication and a data time type; wherein
the data time duplication is used to indicate whether times at which time series data of different time series data instance resources are collected are allowed to be the same; and
the data time type is used to indicate whether the time at which the time series data is collected is a relative time or an absolute time.

27. The method according to claim 26, wherein the attribute information of the time series data resource further comprises a period and data detection.

28. The method according to claim 22, wherein the processing, by the Hosting CSE, the time series data resource according to the operation type and the attribute information of the time series data resource specifically comprises:
if the operation type is create, verifying, by the Hosting CSE, the attribute information of the time series data resource, and after the verification succeeds, creating the time series data resource; or
if the attribute information of the time series data resource further comprises the period and the data detection, detecting, by the Hosting CSE, the time series data according to the period, and when the time series data is missing, storing, by the Hosting CSE, a time at which the time series data is missing.

29. A time series data instance resource management method, comprising:
receiving, by a Hosting CSE, an operation request for a time series data instance resource, wherein the operation request for the time series data instance resource is sent by an AE or a CSE, and the operation request carries an operation type and attribute information of the time series data instance resource; and
processing, by the Hosting CSE, the time series data instance resource according to the operation type and the attribute information of the time series data instance resource, and sending a processing result to the AE or the CSE.

30. The method according to claim 29, wherein the operation type is one of the following operations: create, delete, update, and obtain.

31. The method according to claim 29, wherein the attribute information of the time series data instance resource comprises at least one of a time at which time series data is collected and a time series data value.
